(19) United States
(12) Patent Application Publication
(10) Pub. No.: US 2007/0263700 A1
(43) Pub. Date: Nov. 15, 2007

(54) High-Pressure Sensor for Pressure-Independent Measurement

(76) Inventors: Thomas Moelkner, Stuttgart (DE); Carsten Kaschube, Nuertingen (DE); Hans-Peter Didra, Kusterdingen-Jettenburg (DE); Michael Kott, Reutlingen (DE)

Correspondence Address: KENYON & KENYON LLP, ONE BROADWAY, NEW YORK, NY, 10004, US

(21) Appl. No.: 10/590,169

(22) PCT Filed: Nov. 19, 2004
(86) PCT No.: PCT/EP04/53020

§ 371 Date: Jun. 8, 2007

(30) Foreign Application Priority Data
Feb. 26, 2004 (DE) 10 2004 009 272.9

(51) Int. Cl. G01K 7/20

(52) U.S. Cl. 374/188

(57) ABSTRACT

A method for pressure-independent temperature determination using a metal diaphragm is provided. A bridge circuit having multiple resistors is provided on this diaphragm. One pair of resistors is near the center of the diaphragm and another pair of resistors is situated at a distance from the center. The resistors are provided on the metal diaphragm in such a way that the tensile elongation of the pair of resistors near the center corresponds in absolute value to compressions of the pair of resistors far from the center.

### FIELD OF THE INVENTION

The present invention relates to pressure-independent temperature determination using a diaphragm.

### BACKGROUND INFORMATION

In addition to piezoelectric quartz crystals, sensor chips are being used today as combustion chamber pressure sensors. When used to detect the pressure prevailing in the combustion chamber of an internal combustion engine, the silicon chip should not be exposed directly to the high temperatures prevailing there, which are on the order of approximately 600° C. This is accomplished with the help of a metallic separating diaphragm and a welded ram of a sufficient length. By micromechanical application of a tiny platform at the center of the diaphragm, the sensor becomes a force sensor.

A combustion chamber pressure sensor designed as a sensor chip is known from the Bosch Automotive Engineering Manual (chief editor Horst Bauer, 23^{rd} updated and expanded edition), Braunschweig, Wiesbaden, Vieweg 1999, ISBN 3-528-03876-4, pages 110-111. To prevent the silicon chip from being directly exposed to the high temperatures of maximum 600° C., a metallic separating diaphragm and a welded ram having a length of a few millimeters are provided. Compressive forces applied by the front diaphragm are introduced into the sensor chip via the ram and through the platform with little additional distortion. In the retracted installed position, the sensor chip is only exposed to operating temperatures below 150° C.

The semiconductor pressure sensor illustration on page 110 of Bosch Automotive Engineering Manual, bottom of the right-hand column, shows a bridge circuit which receives a power supply voltage U₀. The bridge circuit includes shunt resistors R₁ which are stretched under stress and shunt resistors R₂ which are compressed under mechanical stress on a silicon substrate to which they are applied.

Whether applied to a steel diaphragm or a silicon diaphragm, piezoresistive high-pressure sensors configured in the above-described manner and based on an elongation measurement principle are used in numerous systems in the automotive field, including direct gasoline injection, high-pressure storage injection (common rail), driving dynamics regulations and electrohydraulic brakes. Future contemplated use of piezoresistive high-pressure sensors may be in cylinder-selective pressure measurement in the combustion chamber of an internal combustion engine.

For the pressure measurement, multiple resistors are provided on a suitably dimensioned steel diaphragm and are connected in the form of a Wheatstone bridge. By elongation and/or compression of the resistors, the Wheatstone bridge is tuned, yielding an electric signal proportional to the acting pressure. In addition to the desired pressure dependence of the bridge signal, however, the bridge signal has a temperature dependence which must be compensated due to the high accuracy requirements. In known configurations, this is accomplished either by compensation resistors applied to the steel diaphragm or by temperature measurement in the area of the electronic analyzer, subsequently taking into account the output signal calculation.

### SUMMARY

According to the present invention, through suitable dimensioning of the diaphragm geometry and appropriate positioning of strain gauges (DMS) on the diaphragm, the bridge circuit is influenced in such a way that the total resistance of the measurement bridge is independent of the deflection of the diaphragm and thus the total resistance depends only on the temperature of the diaphragm. Therefore, regardless of the pressure to be measured, the temperature of the diaphragm may be determined using the measurement bridge, e.g., the measurement bridge designed as a Wheatstone bridge, and this temperature may be used for compensation purposes. Therefore, a pressure-independent temperature measurement of the diaphragm is possible using the measurement bridge functioning as a sensor element without requiring additional compensation-measuring or temperature-measuring resistors to be applied to the metal diaphragm.

In an advantageous manner, no additional area of the metal diaphragm is required by compensation-measuring or temperature-measuring resistors and their electrical connection points due to the due to the configuration according to the present invention. Therefore, a higher degree of miniaturization is achievable, which is of considerable importance given the space constraint in the cylinder head area of today's internal combustion engines, where pressure sensors are used. Miniaturization of sensor elements also offers advantages with regard to manufacturing costs. The miniaturized combustion chamber pressure sensors greatly increase the possible applications of such sensor elements in internal combustion engines.

Furthermore, additional electric contact points are eliminated by the configuration of the present invention, thereby greatly simplifying the manufacturing process, as well as making it possible to avoid potential failure points, e.g., due to contact breakage. In combustion chamber pressure sensors, the electronic analyzer is located at a great distance from the actual pressure measurement point, where peak temperatures of up to 600° C. may occur, because of the maximum allowed temperature of approximately 140° C. Thus, with the pressure sensors used in the past, a temperature measurement in the area of the electronic analyzer would yield a signal far too inaccurate for temperature compensation of the Wheatstone measurement bridge. The measurement accuracy of the combustion chamber pressure sensor may be greatly improved by measuring and analyzing the pressure-independent bridge resistance as provided in the present invention.

### BRIEF DESCRIPTION OF THE DRAWINGS

FIGS. 1a, 1b, 1c, and 1d show conventional embodiments of strain gauges (DMS) provided on a metal diaphragm.

FIG. 2 shows a metal diaphragm according to the present invention having strain gauges applied thereto in the deflected state.

FIG. 3 shows a cross section of the diaphragm material having elongation and compression maximums.

### DETAILED DESCRIPTION

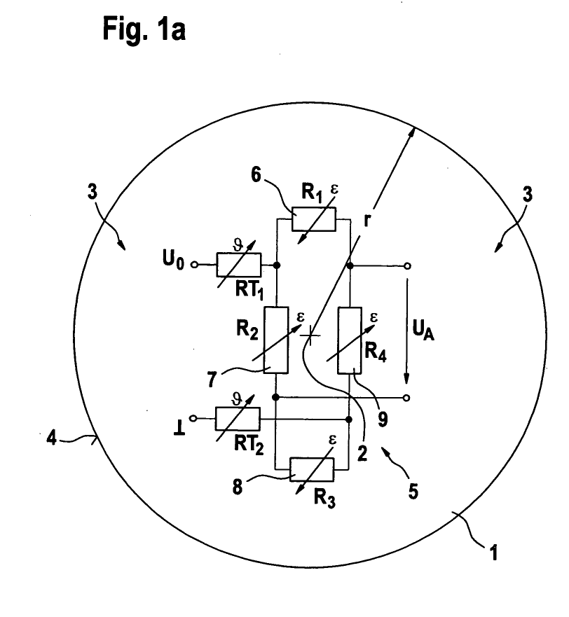

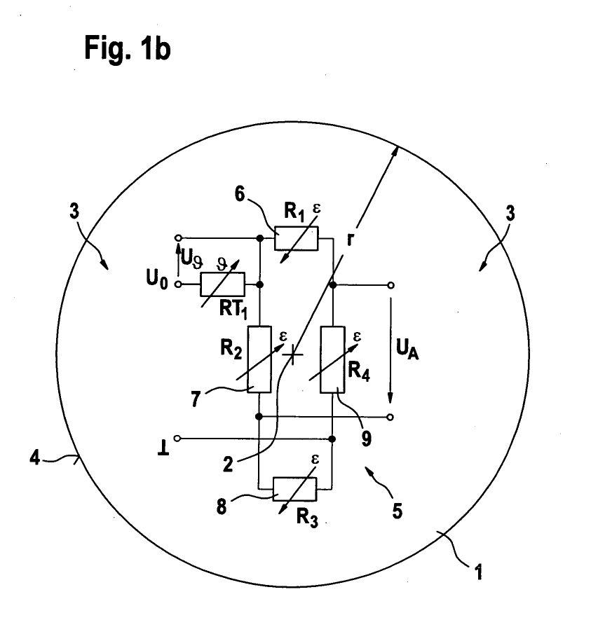

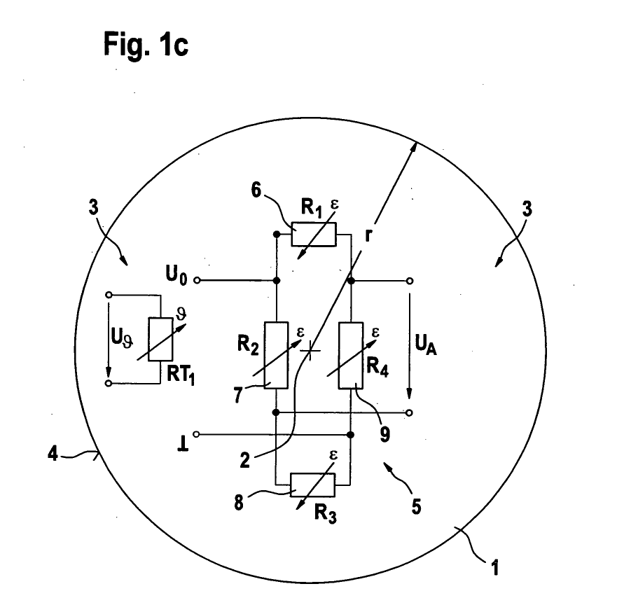

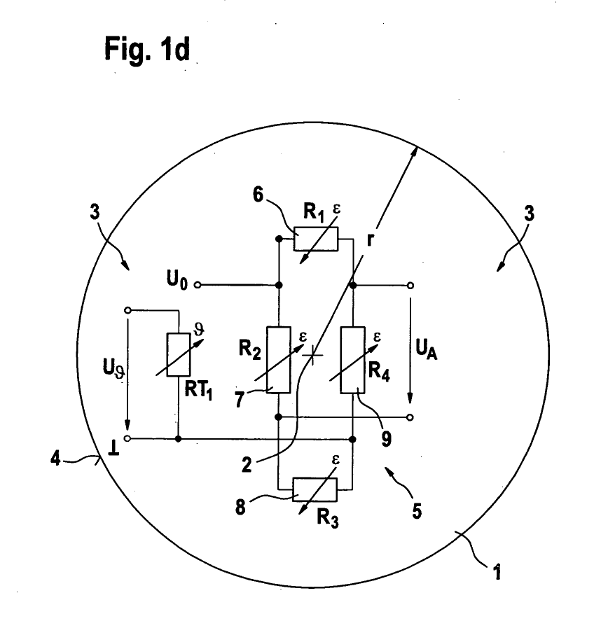

The bridge circuits on a steel diaphragm as shown in FIGS. 1a, 1b, 1c and 1d represent the conventional configurations.

A bridge circuit 5, which may be designed as a Wheatstone bridge circuit, is applied to a metal diaphragm 1. Bridge circuit 5 includes multiple resistors R₁, R₂, R₃ and R₄, characterized by reference numerals 6, 7, 8 and 9. Metal diaphragm 1 may be a steel diaphragm, the center of which is labeled as 2, and having a radius r. The peripheral areas, i.e., the areas at a greater distance from center 2 of metal diaphragm 1, are each indicated by reference numeral 3. The edge of metal diaphragm 1 is labeled with reference numeral 4.

Resistors R₁, R₂, R₃ and R₄ connected in bridge circuit 5 may be strain gauges. Bridge circuit 5 is connected to a power supply voltage U₀. Measurement voltage U_{A} is tapped between resistors R₁ and R₄, or between R₂ and R₃.

Resistors R₁, R₂, R₃ and R₄ provided on metal diaphragm 1 are positioned so that they experience an elongation or compression when a pressure acts on metal diaphragm 1. The bridge circuit is tuned in this way, yielding a voltage signal U_{A}, which is proportional to the pressure acting on metal diaphragm 1, the voltage signal being sent to an analyzer circuit. This signal U_{A} depends not only on pressure but also on temperature. Pressure dependence is desired but the temperature dependence of thus obtained signal U_{A} necessitates the use of compensation resistors RT₁, RT₂ to meet the high accuracy requirements for use as a combustion chamber pressure sensor. With the configuration illustrated in FIG. 1, additional compensation resistors RT₁, RT₂ are applied to metal diaphragm 1 to compensate for the temperature dependence of measurement signal U_{A}. However, these compensation resistors RT₁, RT₂ influence only the temperature dependence of the sensitivity, and the zero point remains uncompensated. Another possibility for eliminating the temperature dependence which influences signal accuracy is to measure the temperature in the area of the electronic analyzer and to correct output signal U_{A} by the temperature influence, thereby improving the accuracy of measurement signal U_{A}. However, when used as a combustion chamber pressure sensor, the electronic analyzer is located at a great distance from the actual pressure measurement point, where peak temperatures of 600° C. occur, because of the analyzer's temperature ceiling of approximately 140° C. The signal obtained by temperature measurement in the area of the electronic analyzer is therefore far too inaccurate for temperature compensation of the bridge circuit, due to the temperature limitation on the electronic analyzer. In the variants depicted in FIGS. 1a, 1b, 1c and 1d, compensation resistors RT₁, RT₂ which are additionally used require an increased amount of space on the metal diaphragm, while also necessitating an additional contacting pad.

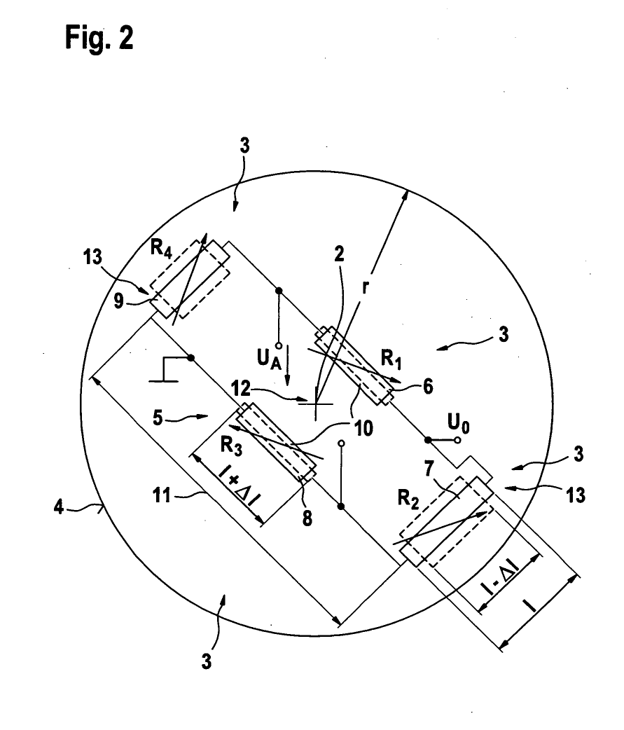

FIG. 2 shows the configuration of a bridge circuit according to the present invention, applied to a metal diaphragm.

Metal diaphragm 1 shown in FIG. 2 is a steel diaphragm including a center 2 and peripheral areas 3 extending radially. Metal diaphragm 1 is bordered by edge 4 and is provided with bridge circuit 5 which is designed according to the embodiment known from the related art, as depicted in FIG. 1. Bridge circuit 5 is also designed as a Wheatstone bridge and includes four interconnected resistors R₁, R₂, R₃ and R₄, identified by reference numerals 6, 7, 8 and 9. Bridge circuit 5 is supplied with power by a power supply voltage U₀; the voltage tap for the resulting measurement signal, i.e., measurement voltage U_{A}, takes place between resistors R₁ and R₄ on the one hand, and between resistors R₂ and R₃ on the other hand.

Resistors R₁, R₂, R₃ and R₄ shown in FIG. 2 are strain gauges. The positions where resistors R₁, R₂, R₃ and R₄ are applied to the metal diaphragm 1 may be determined with the help of the finite element method (FEM). After creating a geometric model of metal diaphragm 1 and defining suitable boundary conditions, the finite element method yields as the result the elongation topology of metal diaphragm 1 under compressive stress.

In addition to other optimization parameters, the boundary conditions under which the finite element method is used also take into account the fact that the radial elongation of metal diaphragm 1 is equal in absolute value to the compression (ε_{compress}) of metal diaphragm 1. In addition, the nominal pressure acting upon metal diaphragm 1 may also be taken into account as a modulation parameter. As geometric boundary conditions, the diameter of metal diaphragm 1 and the diaphragm thickness are taken into account. The diaphragm thickness may also vary in the radial direction, which may be taken into account as an influencing parameter in the finite element method. In addition, the diaphragm height of metal diaphragm 1, and the material properties of the metal diaphragm 1 may also be taken into account. In addition to designing the diaphragm as metal diaphragm 1, it may also be made of a ceramic material.

Areas in which both the elongation maximums and the compression maximums occur when pressure is acting on metal diaphragm 1 arise from the elongation topology of metal diaphragm 1. Maximum elongation 12 typically occurs at center 2 of metal diaphragm 1 because it is at the greatest distance from the clamping point, i.e., edge 4 of metal diaphragm 1, and consequently may be deflected to the greatest extent by the pressure acting on metal diaphragm 1. Compression maximums 13 are usually located in peripheral area 3 of metal diaphragm 1, i.e., they are usually in the area of edge 4 of metal diaphragm 1, which may be a steel diaphragm. The boundary conditions of FEM simulation are advantageously selected so that, following geometric optimization, maximum elongation 12 occurring at center 2 of metal diaphragm 1 corresponds in absolute value to the absolute values of compression maximums 13 in peripheral area 3 of metal diaphragm 1. The positions of four resistors R₁, R₂, R₃ and R₄ may be selected on the basis of the elongation topology determined by the geometric model and optimized by suitable shaping of metal diaphragm 1 so that the absolute values of elongations Δ1 correspond to those of compressions −Δ1.

In these positions, which are determined by determination of the elongation topology of metal diaphragm 1, four resistors R₁, R₂, R₃ and R₄ designed as strain gauges are situated on metal diaphragm 1. When the four resistors of bridge circuit 5 are provided on metal diaphragm 1 in the positions shown in FIG. 2, the change in resistance under compressive stress on all four resistors R₁, R₂, R₃ and R₄ is identical in terms of absolute value. The diagram in FIG. 2 shows that both resistors R₁ and R₃ identified by reference numerals 6 and 8, respectively, are situated in the area of metal diaphragm 1 near the center, forming a pair of resistors 10 near the center. The two resistors are stretched from their original length to a length l+Δl because of the elongations prevailing in the area of center 2 of the pressure action on metal diaphragm 1. Elongation Δl of two resistors R₁ and R₃ designed as strain gauges is identical. Instead of the orientation of two resistors R₁ and R₂ as shown in FIG. 2, they may be situated parallel to the horizontal axis or parallel to the vertical axis of metal diaphragm 1. However, the positions of a peripheral resistor pair 11 are located in periphery 3 of metal diaphragm 1 and in the areas where compression maximums 13 occur. When pressure acts on metal diaphragm 1 from one side, resistor pair 10 near the center is under elongation stress, i.e., is stretched by amount Δl.

Peripheral resistor pair 11 is compressed by distance −Δl, as indicated by the dotted line representing two resistors R₂ and/or R₄. Compression l−Δl indicates the length by which two resistors R₁ and/or R₄ which are in the compression area of metal diaphragm 1 are compressed by pressure acting on metal diaphragm 1. The stretching of two resistors R₁ and R₃ situated near the center, forming resistor pair 10 near the center, is represented by l+Δl and is also indicated by dashed lines. Due to the arrangement of resistor pair 10 near the center and peripheral resistor pair 11, absolute value of −Δl of compressed resistors R₂ and R₄ is identical to length Al of resistor pair 10 situated near the center. Accordingly, tensile elongations Δl of two resistors R₁ and R₃ near the center correspond to compressions −Δl of resistors R₂ and R₄ which are situated farther to the outside in periphery 3 of metal diaphragm 1 and are under compressive stress. In this case, the total resistance of bridge circuit 5 depends only on the temperature and is thus independent of the applied pressure which is to be determined by the deflection of metal diaphragm 1. Thus the temperature of bridge circuit 5 may be determined by measuring total resistance R_{TOT} and may then be used for compensating the temperature influence.

The arrangement of resistors R₁, R₂, R₃ and R₄ illustrated in FIG. 2 results in the total resistance of bridge circuit 5 becoming independent of the deflection of metal diaphragm 1 and thus depends only on the temperature of metal diaphragm 1. Therefore, regardless of the pressure to be measured, the temperature of metal diaphragm 1 may be determined using bridge circuit 5 and used for compensation purposes. This ensures that the temperature to which bridge circuit 5 is exposed is the true temperature by whose influence resulting measurement signal U_{A} of bridge circuit 5 is to be compensated. Measurement inaccuracies due to temperature compensation in the area of the electronic analyzer that is situated at a great distance from metal diaphragm 1 for reasons of thermal stress, may be eliminated directly by the temperature compensation according to the present invention, i.e., the positioning of resistors R₁, R₂, R₃ and R₄ of bridge circuit 5.

Thus, the present invention makes it possible to achieve a significantly more accurate pressure-independent temperature determination of metal diaphragm 1. In contrast to the known configurations, additional compensation-measuring or temperature-measuring resistors may be omitted due to the configuration of the present invention. Furthermore, the combustion chamber area required to apply the compensation-measuring or temperature-measuring resistors is eliminated so that the electric connection points for the compensation-measuring and temperature-measuring resistors may also be omitted. Thus, on the whole, metal diaphragm 1 may be much smaller because much less area is needed. The elimination of the electric contacting points of the additional compensation-measuring or temperature-measuring resistors required in the conventional arrangement prevents weaknesses that would be potential failure points.

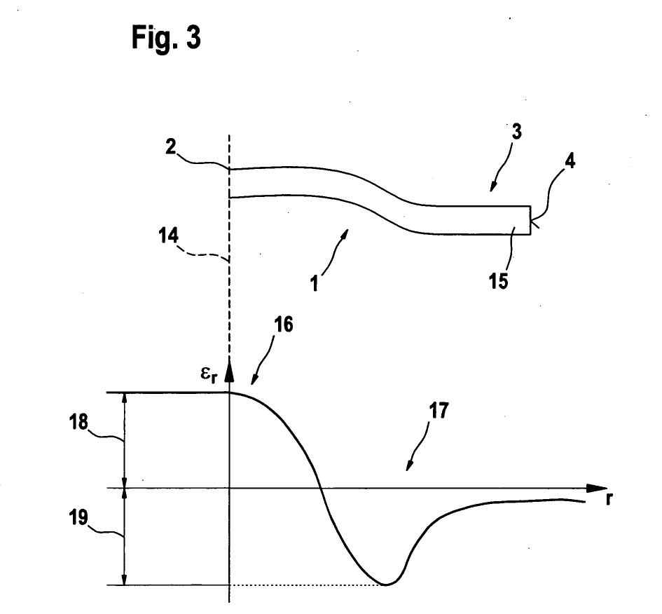

FIG. 3 shows a cross section of the diaphragm material showing the position of the elongation maximums and compression maximums.

Metal diaphragm 1 shown partially in cross section in FIG. 3 is symmetrical to axis of symmetry 14. The diaphragm material may be a metallic material or a ceramic material. When pressure acts on metal diaphragm 1, it assumes the form illustrated in FIG. 3. Metal diaphragm 1 is elongated in the area of center 2 and is compressed at periphery 3. The position of resistor 10 near the center is indicated by reference numeral 16 in FIG. 3, while the position of resistor pair 5 at a distance from the center, situated in periphery 3 of metal diaphragm 1, is indicated by reference numeral 17. Owing to the geometric deformation of diaphragm material 15, center 2 undergoes elongation in the radial direction. Radial elongation ε_{r,elong} which occurs at center 2 of metal diaphragm 1 corresponds in terms of absolute value to radial compression ε_{r,compress} in the area of periphery 3 of metal diaphragm 1. The elongation in the radial direction in radial elongation area 18 corresponds in absolute value to radial compression ε_{r,compress}, indicated by reference numeral 19 in peripheral area 3 of metal diaphragm 1.

1-8. (canceled)

9. A method for pressure-independent temperature determination, comprising:
providing a bridge circuit having a plurality of resistors on a diaphragm, a first resistor pair being positioned near the center of the diaphragm and a second resistor pair being positioned at a distance from the center of the diaphragm;
wherein the first and second resistor pairs are positioned on the diaphragm such that tensile elongation of the first resistor pair positioned near the center of the diaphragm corresponds to compression of the second resistor pair positioned at a distance from the center of the diaphragm.

10. The method as recited in claim 9, wherein the diaphragm is a metal diaphragm, and wherein the first resistor pair is positioned near the center of the diaphragm in an area where elongation maximums occur when pressure acts on the metal diaphragm.

11. The method as recited in claim 9, wherein the diaphragm is a metal diaphragm, and wherein the second resistor pair is positioned at a distance from the center in an area where compression maximums occur.

12. The method as recited in claim 10, further comprising:
determining, by finite elements method, the area of the metal diaphragm where the elongation maximums occur.

13. The method as recited in claim 11, further comprising:
determining, by finite elements method, the area of the metal diaphragm where the compression maximums occur.

14. The method as recited in claim 9, wherein the absolute value of the elongation and the absolute value of the compression are identical.

15. The method as recited in claim 9, wherein the diaphragm is a metal diaphragm, and wherein the configuration of the metal diaphragm is optimized geometrically as part of finite elements method simulation.

16. The method as recited in claim 15, wherein geometric boundary conditions including at least one of the diameter of the metal diaphragm, the thickness of the metal diaphragm and the height of the metal diaphragm are taken into account as part of the finite elements method simulation.

17. The method as recited in claim 15, wherein nominal pressure acting on the metal diaphragm is taken into account as part of the finite elements method simulation.
